(19) United States
(12) Patent Application Publication
(10) Pub. No.: US 2018/0012245 A1
(43) Pub. Date: Jan. 11, 2018

(54) Systems and Methods For Using Video Testimonials To Promote Product Sales

(71) Applicant: Stop By Say Hi, Inc., Scottsdale, AZ (US)

(72) Inventors: Sam Parker, Gilbert, AZ (US); Andrew James MacLennan, Cave Creek, AZ (US)

(21) Appl. No.: 15/594,366

(22) Filed: May 12, 2017

Related U.S. Application Data
(60) Provisional application No. 62/359,613, filed on Jul. 7, 2016.

(51) Int. Cl. G06Q 30/02

(52) U.S. Cl. CPC G06Q 30/0214; G06Q 30/0253

(57) ABSTRACT

Methods and apparatus for promoting on-line product sales. The method includes: playing a sequence of video testimonials recorded by respective creators; identifying a motivating video in response to a product purchase; adjusting the position of the motivating video within the sequence; and providing a reward to the creator of the motivating video.

### CROSS REFERENCE TO RELATED APPLICATION

The present application claims priority to and incorporates by reference the entirety of U.S. provisional application Ser. No. 62/359,613 filed Jul. 7, 2016 and entitled “Systems and Methods For Recording And Displaying Continuously Looped Testimonials”.

### TECHNICAL FIELD

The present invention relates, generally, to the use of video testimonials to promote on-line product sales and, more particularly, to techniques for incenting customers to upload video testimonials to a retail site for incorporation into an endless video replay loop.

### BACKGROUND

Various techniques for using video testimonials to promote product sales are described in Avedissian U.S. Publication 2014/0165086 A1 and Cassidy U.S. Publication 2013/0166382 A1. The entire contents of the foregoing are hereby incorporated into this disclosure. Presently known systems, however, tend to incent the purchaser of a product, and are not well equipped to proactively incent customers to record and upload video testimonials which effectively motivate others to purchase specific products.

Methods and apparatus are thus needed which overcome the limitations of the prior art.

Various features and characteristics will also become apparent from the subsequent detailed description and the appended claims, taken in conjunction with the accompanying drawings and this background section.

### BRIEF SUMMARY

The present invention provides systems and methods for stitching a plurality of individual video testimonials together into an endless loop for viewing by potential purchasers of products. Various embodiments involve: i) placing a distinctive icon proximate a product ad on a retail website; ii) when the icon is clicked, the user is presented with a “record” and a “view” option; iii) each newly recorded video is placed (prioritized) within a loop according to the recorder's status; iv) when a product is purchased, the most recent video is deemed the motivating video and moved up in the loop, and the recorder's status is adjusted accordingly; v) negative reviews are not published, but used to improve product quality; vi) videos for unrelated products previously recorded by the author of a motivating video are also moved up in their loops; vii) the recorder of the motivating video receives an incentive; viii) purchasing a product is initially required in order to record a first video, but an elevated status allows a recorder to upload videos for products he did not purchase; ix) a consumer hitting “buy now” time stamps the motivating video, providing specific feedback to the recorder to enhance his technique; x) achieving gold status allows recorders to also see other gold status time stamps to view their techniques; and xi) achieving silver status allows consumers to send questions to the recorder, with each inquiry accumulating additional incentives.

It should be noted that the various inventions described herein, while illustrated in the context of on-line product sales, are not so limited. Those skilled in the art will appreciate that the inventions described herein may also contemplate looped videos to facilitate social engagement in the context of birthdays, weddings, anniversaries, and the like, or to promote professional services.

Various other embodiments, aspects, and features are described in greater detail below.

### BRIEF DESCRIPTION OF THE DRAWING FIGURES

Exemplary embodiments will hereinafter be described in conjunction with the appended drawing figures, wherein like numerals denote like elements, and:

FIG. 1 is a flow chart illustrating an exemplary high level method of recording, stitching, and viewing recorded testimonials in accordance with various embodiments;

FIG. 2 is a schematic layout diagram of an exemplary hardware implementation of a system for recording and playing looped testimonials in accordance with various embodiments;

FIG. 3 is a flow chart illustrating an exemplary detailed method of recording, stitching, and viewing recorded testimonials for personal use in accordance with various embodiments;

FIG. 4 is a schematic layout diagram of an exemplary hardware implementation of a system for recording and playing looped testimonials for commercial use in accordance with various embodiments;

FIG. 5 is a flow chart illustrating an exemplary detailed method of recording, stitching, and viewing recorded testimonials for commercial use in accordance with various embodiments;

FIG. 6 is a timeline flow diagram illustrating sequential steps associated with recording and viewing looped testimonials in accordance with various embodiments;

FIG. 7 is an exemplary screen shot depicting a welcome greeting in accordance with various embodiments;

FIG. 8 is an exemplary screen shot for selecting a recipient in accordance with various embodiments;

FIGS. 9 and 10 are exemplary screen shots depicting a various recording prompts in accordance with various embodiments;

FIG. 11 is an exemplary screen shot depicting a testimonial management menu in accordance with various embodiments;

FIG. 12 is an exemplary screen shot showing how the sequence of testimonials may be reordered in accordance with various embodiments;

FIG. 13 is an exemplary screen shot of a product listing on a retail web site in accordance with various embodiments;

FIG. 14 is an exemplary matrix or spreadsheet which monitors various metrics associated with products, video testimonials, and reviewers in accordance with various embodiments; and

FIG. 15 is a flow diagram illustrating an exemplary method of promoting product sales by adjusting the priority of a video deemed to motivate a sale and incenting the creator of the motivating video in accordance with various embodiments.

### DETAILED DESCRIPTION OF PREFERRED EXEMPLARY EMBODIMENTS

The following detailed description of the invention is merely exemplary in nature and is not intended to limit the invention or the application and uses of the invention. Furthermore, there is no intention to be bound by any theory presented in the preceding background or the following detailed description.

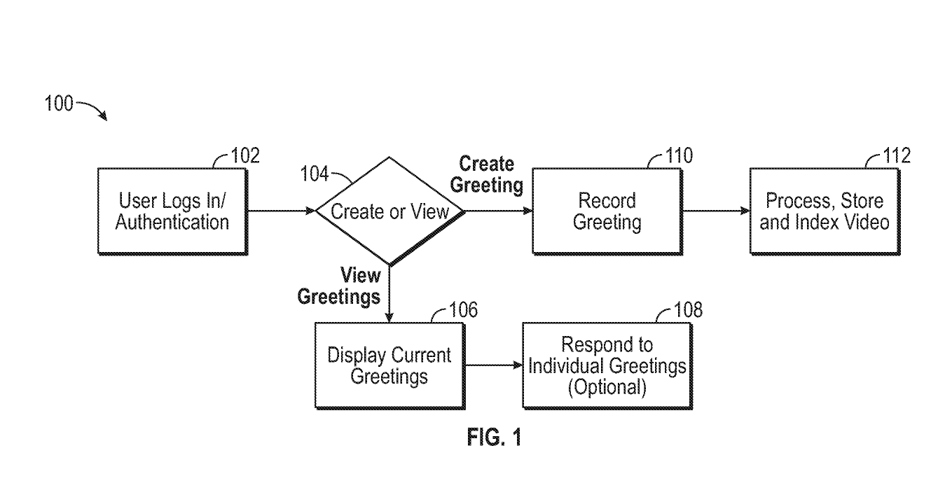

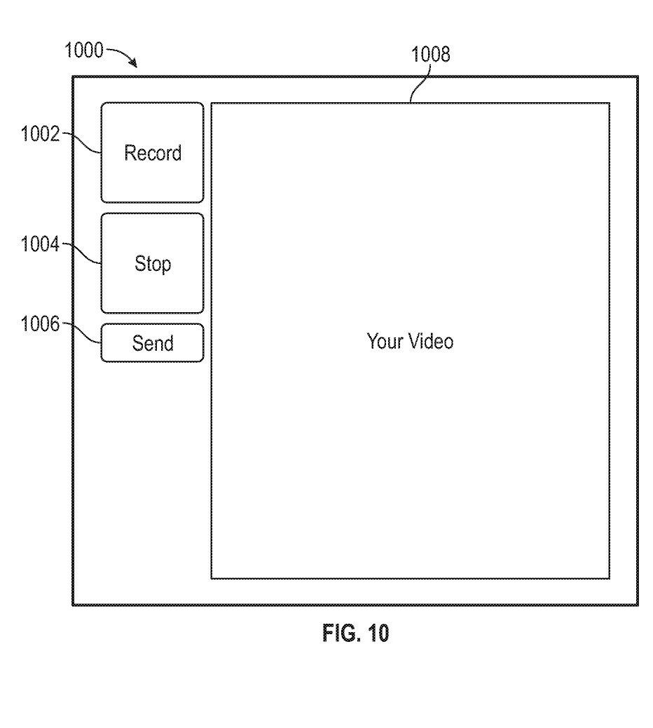

Various embodiments of the present invention relate to systems and methods for automatically stringing together video testimonials recorded by different people into a single loop for viewing by the intended recipient in a manner which avoids having to successively click on new videos. In the context of FIGS. 1-12, the videos may be used to promote social engagement and, thus, intended recipient may be a relative, friend, or colleague. In the context of FIGS. 13-15, the videos are used to promote product sales and, thus, the intended recipient may be a customer viewing products on a retail web site.

In a preferred embodiment various features and functions may be implemented by a software application configured for use by: i) individuals wanting to send and view short video clips (e.g., social greetings, product endorsements) to friends and family recorded via a webcam; or ii) on-line retailers to display testimonials recorded by satisfied customers for consumption by potential customers.

In a first embodiment involving social occasions, the user may access the application through a web browser where the user is prompted with a login page at a dedicated web portal. Alternatively, the system may be distributed using a clickable module which may be displayed on a Facebook or other user page. Once logged in, the user is prompted to record a new video or view all video greetings that have been sent to the user, in reverse chronological order, in an endless loop. If the user elects to record a new video, the user may be prompted to identify the intended recipient. Once the user has submitted a valid username, the user may click the record button to enable the user's webcam and begin recording the greeting. Once the user has completed the greeting, the user can click the “stop” button. The user may then be asked to confirm that they wish to send their greeting, create a new greeting, or view greetings. If the user elects to send the greeting, the greeting is stitched or otherwise merged into an endless loop associated with the intended recipient.

In an alternative embodiment involving the use of stitched video testimonials to promote product sales, once the user has logged into the application, for example by clicking an icon disposed proximate a product ad on a retail web site, the user is invited to record a video testimonial in a similar manner to that described above.

In either case, if the user has sufficient administrative privileges to manage the looped videos, the user may be presented with two scrolling lists of videos: one for videos currently in the “play” list; and the other for videos in a “pending” list. The user can view videos from the pending list, delete them, send them to a quality control group for further analysis, move them to the play list, or adjust the priority of the videos within a play list. In this way the user can implement quality control and filter out undesirable videos, such as inappropriate or distasteful messages or themes, or negative product reviews not appropriate for publication.

In various embodiment, the playlist plays on an endless loop seamlessly either in the form of a single integrated video file, or as individual video files played in the sequence in which they were recorded, or as may be defined algorithmically or subjectively by an administrative user. When using one long video, every time the list is changed in by adding a video or changing sequence, a new video file may be rendered and the old one deleted. Alternatively or in addition to the foregoing, individual clips may be stored separately. Alternatively, each video may be assigned a unique ID tag which defines a position within the loop (e.g., chronological or reverse chronological order), which sequence tag may be changed algorithmically or by an administrator.

The application itself may be configured to run off of a Linux dedicated web server or analogous system that manages video files and user ids stored in a database server. In one embodiment, the application may be created with HTML5/CSS3/PHP/JS and rendered in a client side web browser. Every video created is given a unique ID and suffix which indicates its position in the playlist and stored in a directory on the server.

Referring now to FIG. 1, a flow chart too illustrates an exemplary high level method of recording, stitching, and viewing recorded testimonials. In particular, the method includes user login/authentication (Step 102), whereupon the system prompts the user (Step 104) to either create a new greeting (testimonial) or view existing greetings. If the user elects to create a new greeting, the system guides the user through the recording process (Step 110) as described in greater detail below. Once the greeting is recorded, the system processes and stores (Step 112) the video for subsequent playback. In a preferred embodiment, the system assigns the same filename to each video intended to be merged into a single loop, followed by a sequential tag. The videos are then stored and retrieved using this filename/tag scheme, such that playback of sequential videos appears seamless to the viewer.

With continued reference to FIG. 1, if the user elects to view the current playlist, the then current version of the endless loop is played (Step 106), whereupon the system may prompt the user to reply to individual greetings or to submit a question to a particular product reviewer (Step 108), if desired.

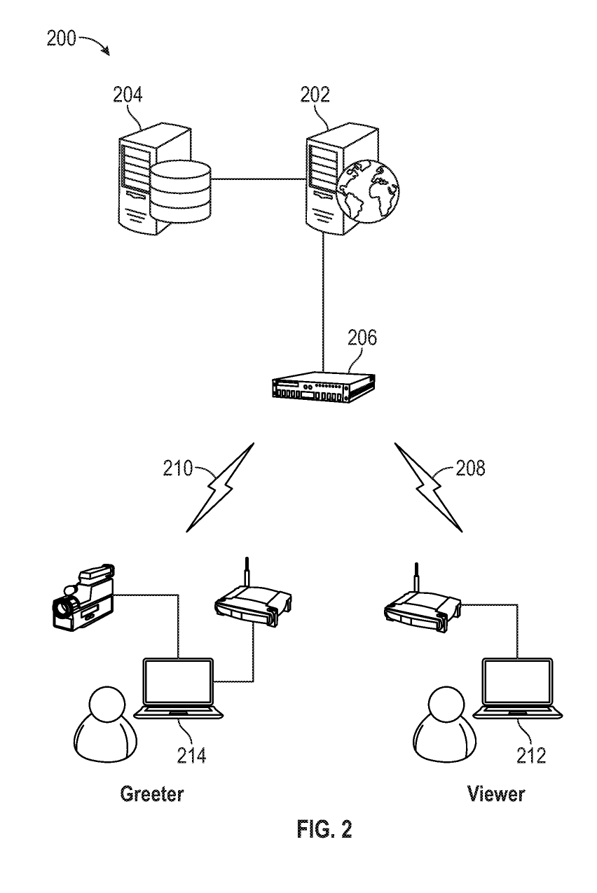

FIG. 2 is a schematic layout diagram of an exemplary hardware implementation of a system for recording and playing looped testimonials for personal use. In particular, a system 200 includes a recording/playback server 202, a database server 204, a hub 206, a greeter user computer 214 connected to the hub via a first communications link 210, and a viewer user computer 212 connected to the hub via a second communications link 208. Alternatively, the application may involve an icon disposed proximate a product advertisement on a retail web site. Upon clicking the icon, the application running on the same server as the retail web site may invoke software modules for implementing the features described herein, or direct the user to a separate web page or portal.

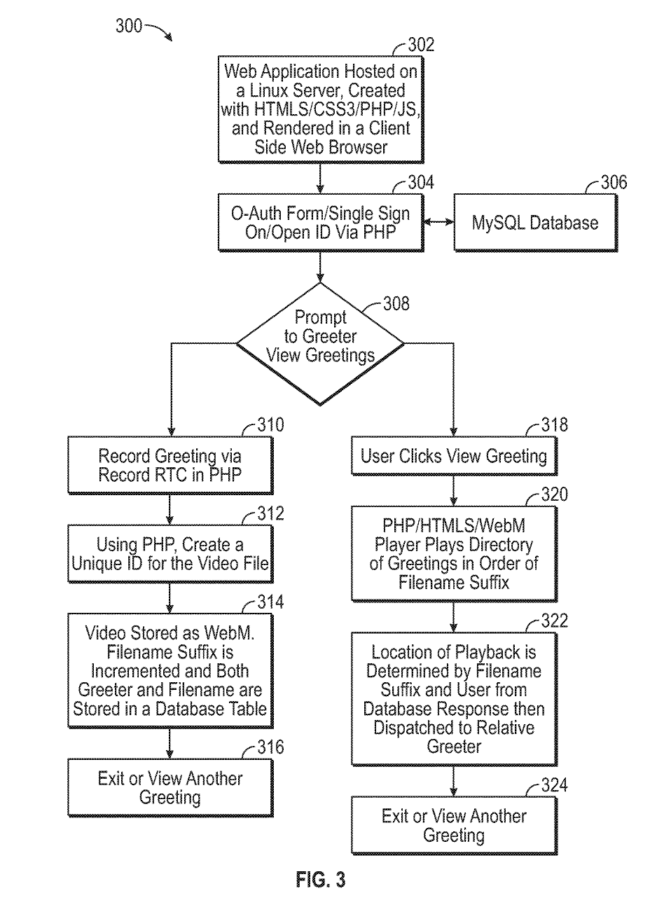

FIG. 3 is a flow chart illustrating an exemplary detailed method 300 of recording, stitching, and viewing recorded testimonials for in accordance with various embodiments. More particularly, the method 300 includes a web application is provided (Step 302), such as an application hosted on a Linux server created with HTML5/CSS3/PHP/JS, and rendered in a client side web browser. After user login and/or authentication (Step 304), the user's role and/or credentials (e.g., greeter/viewer, privilege level) are stored in a database (Step 306).

The system then prompts the user to indicate whether the user desires to create a testimonial or view existing testimonials (Step 308). If the user chooses the greeter interface, the system prompts the user to identify the recipient and record the greeting (Step 310). The system then processes, stores, and indexes the video testimonial, for example using PHP scripting language, and optionally creates a unique ID for the video (Step 312). In one embodiment, the system stores the video file in a group directory containing all greetings for a particular viewer/event, for example as a WebM, and increments the filename suffix for successive videos (Step 314). The system may then prompt toe user to exit or to leave another greeting for the same or a different viewer/event (Step 316).

Returning now to Step 308 of FIG. 3, if the user elects to view current videos, for example as a recipient, the system may display an indication as to whether any new videos have been posted/uploaded since the loop was last viewed (Step 318). The video player (e.g., PHP/HTML5/WebM player) may then display a list of looped videos (Step 320), for example ordered by filename suffix (e.g., tag). The location within the loop at which playback is initiated and/or re-commenced may be selected by the user, for example by clicking on indicia associated with a particular filename/extension. Consequently, during the playback experience, the viewer may stop at any time and type/record a response to a greater/customer, as desired (Step 322). When finished viewing, the user may exit or return to a previous action (Step 324).

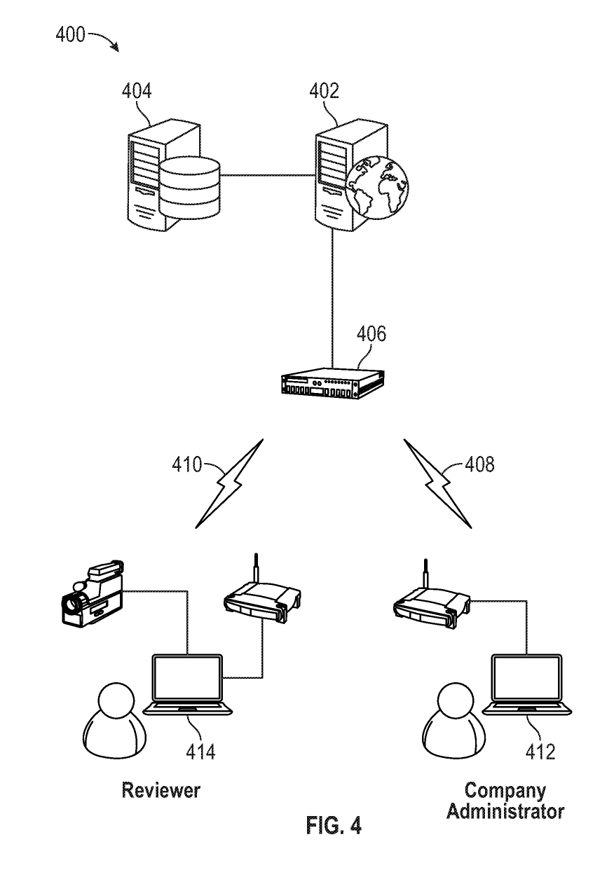

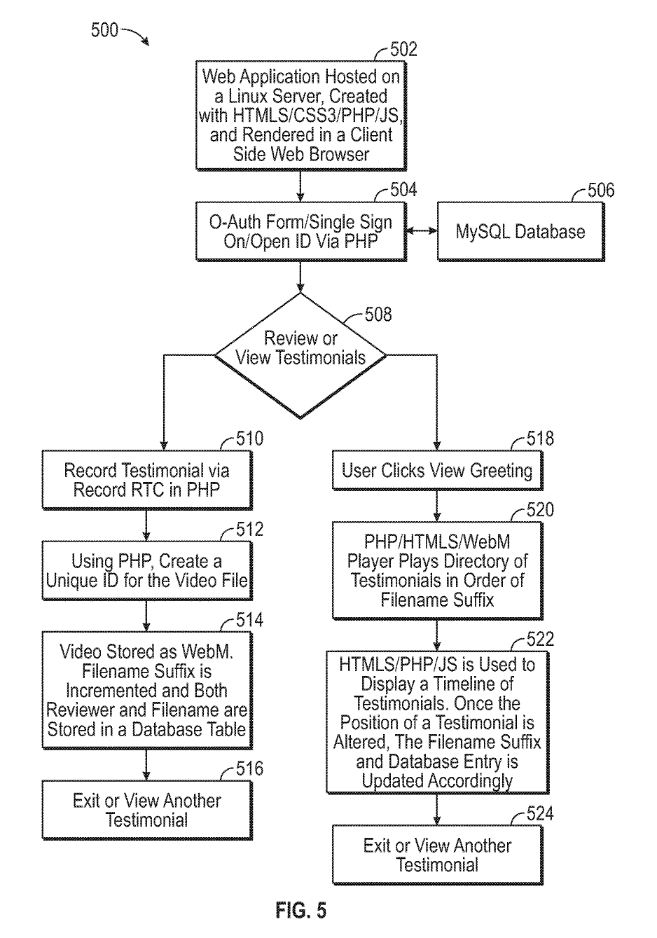

FIG. 4 is a schematic layout diagram of an exemplary hardware implementation of a system for recording and playing looped testimonials for commercial use, and is generally analogous to the layout of FIG. 2, the principal difference being that a company administrator 412 is the viewer/administrator. Similarly, FIG. 5 is a flow chart illustrating a method of recording, stitching, and viewing testimonials for commercial use, and is generally analogous to the method of FIG. 3.

With continued reference to FIG. 5, after the system displays the then current testimonials (Step 520), the user may remove, rearrange, edit, or otherwise alter the sequence of testimonials (Step 522), for example using an interactive timeline or other graphical paradigm (Step 522). If a viewer elects to re-order the videos, the system may account for the re-ordering by updating the affected filenames/suffixes accordingly.

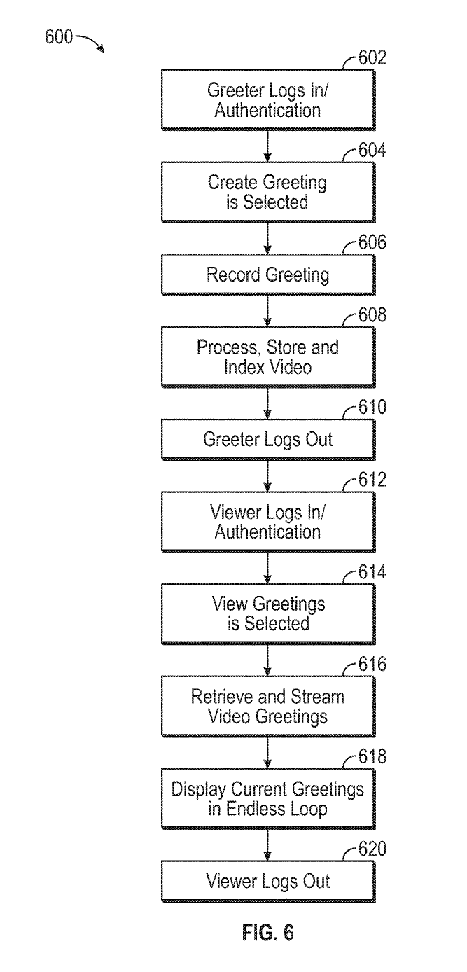

FIG. 6 is a timeline flow diagram 600 illustrating sequential steps associated with recording and viewing looped testimonials in accordance with various embodiments. More particularly, the method 600 includes logon/authentication (Step 602), whereupon the user selects the option to create a greeting (Step 604). After the written, graphical, audio, and/or video testimonial is recorded (Step 606), the video is processed, stored, and indexed (Step 608), whereupon the greeter eventually logs out (Step 610).

With continued reference to FIG. 6, the method 600 further includes the viewer logging in (Step 612) and electing to view existing testimonials (Step 614). The system retrieves the stream of recorded testimonials (Step 616), and plays the endless loop (Step 618) for the viewer without the viewer having to individually select successive greetings. After reviewing the stitched (looped) videos, the viewer may log off the system (Step 620).

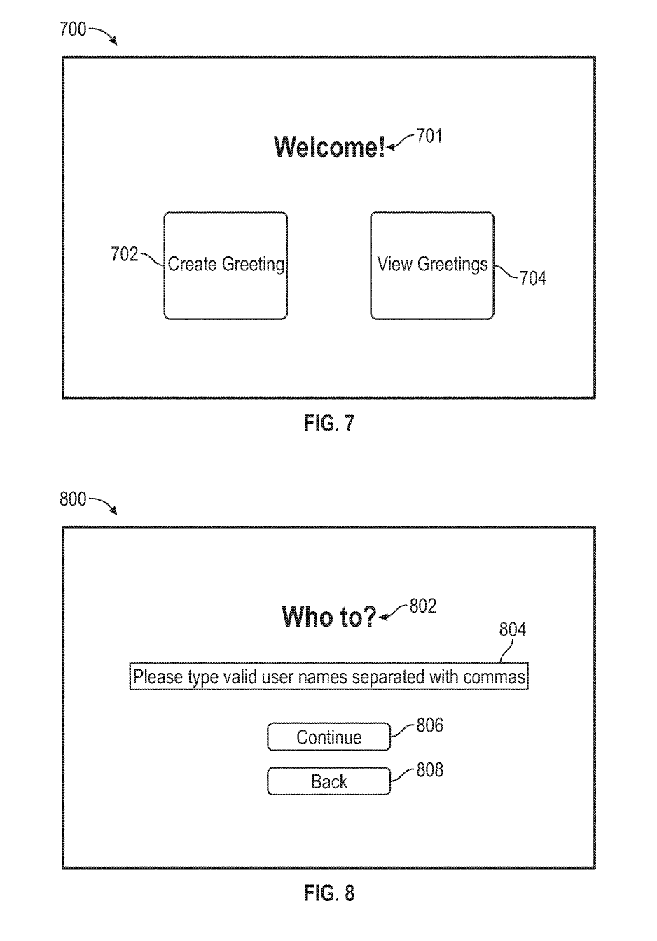

FIGS. 7-12 are screen shots of exemplary user interfaces for facilitating the foregoing techniques. More particularly, FIG. 7 is a screen shot 700 depicting a welcome greeting 701, a first option 702 to create a greeting, and a second option 704 to view greetings.

FIG. 8 is a screen shot 800 inviting a user to select a recipient 802, for example using a pull down menu, a text entry field 804, a search box, or clicking on one of a plurality of available recipients (not shown). Upon identifying the recipient, the user may continue 806 or go back 808 to a previous point in the user interface.

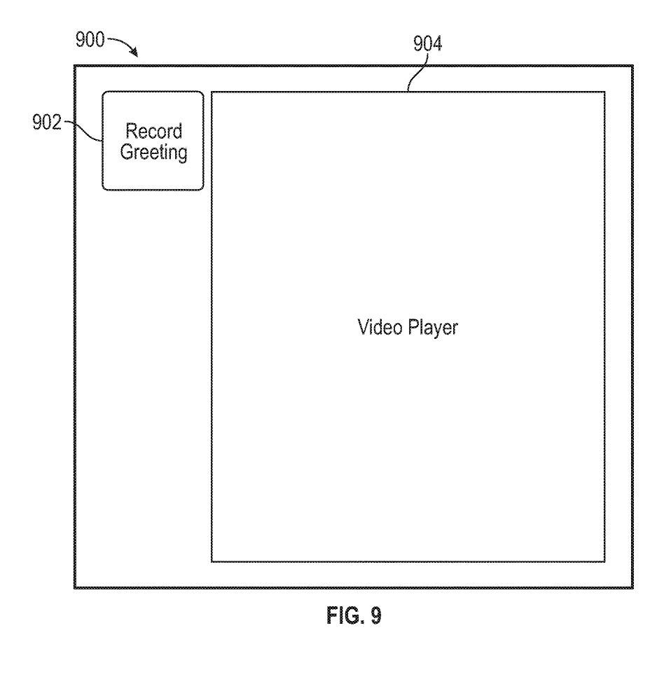

After (or before) selecting a recipient or, alternatively, without selecting a recipient, FIG. 9 illustrates a screen shot 900 including a start button 902 and a player 904, so that the person(s) recording the video may view the video as is it being recorded. During recording, FIG. to illustrates a screen shot 1000 including a record (or resume) button 1002, a stop (or pause) button 1004, a send (or upload) button 106, and a viewing screen 1008.

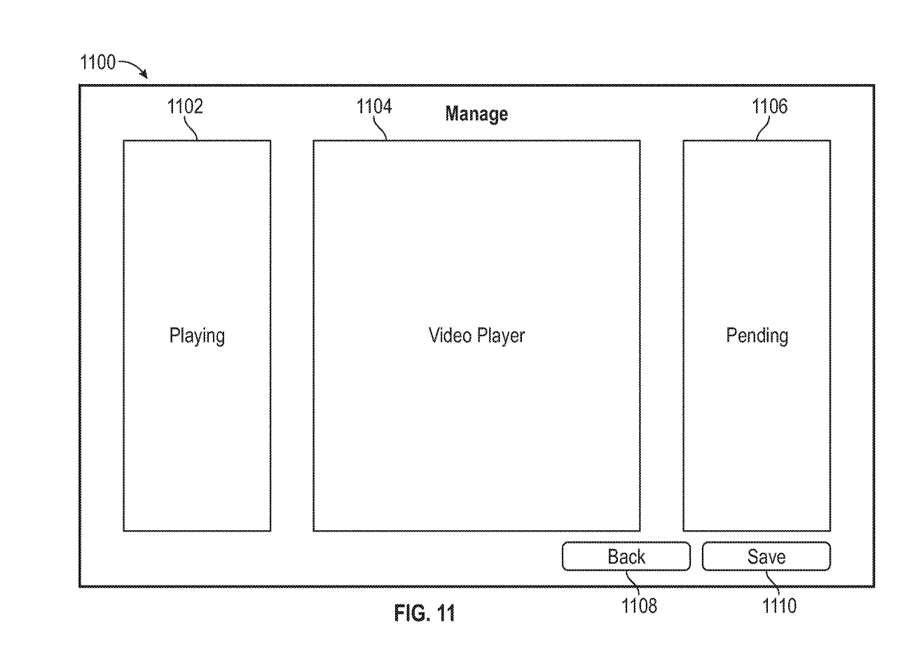

FIG. 11 is an exemplary screen shot 1100 depicting a testimonial management menu including a playing list 1102, a viewing player screen 1104, a pending list 1106, a back button 1108, and a save button 1110. More particularly, a user with sufficient administrative privileges can manipulate the playing list 1102 by selecting videos for deletion, drag them back to the pending list, or drag them up or down in the playing list to change their position in the playing sequence. In the pending list, the user can select one or more video clips to either delete them, edit them, or drag and drop them into the playing list, as desired. Upon editing, the administrative user can “save” the changes, so that the edited loop is displayed when next retrieved for playback.

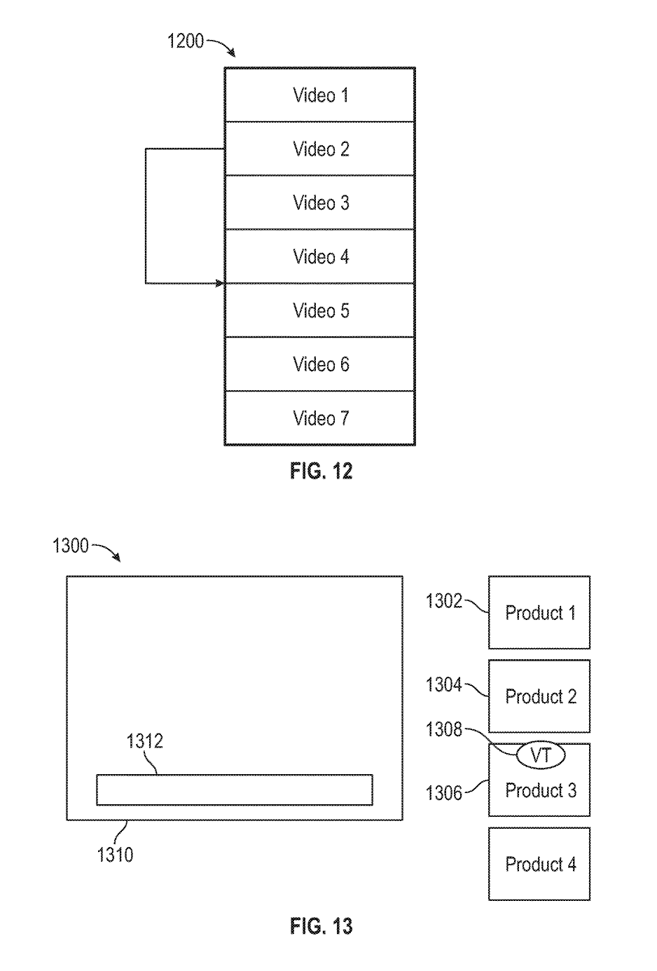

FIG. 12 is an exemplary screen shot 1200 showing how the sequence of testimonials may be reordered, for example by clicking and dragging a video to reorder it within the displayed sequence.

Referring now to FIG. 13, an exemplary screen shot 1300 depicts a product listing on a retail website. More particularly, a product panel is configured to scroll along the right side of the page, revealing successive product advertisements for a first product 1302, a second product 1304, a third product 1306, and so forth. One or more of the ads may include a video testimonial (VT) icon 1308 indicating that video testimonials have previously been recorded for the product and are available for viewing, or that the product vendor is inviting reviewers to upload a video testimonial for the product. The web page further includes a video pane or window 1310 including appropriate controls 1310 including, for example, start, record, stop, skip, buy now, and send a question controls.

Upon clicking the VT icon 1308, the user may be presented with a “record” option which allows the user to create and upload a video testimonial (or audio or other multi-media file), and a “view” option which allows to user to view any existing testimonials. In one embodiment, if a user elects to upload a video, the video may be prioritized (e.g., positioned) within the then current sequence of videos in accordance with the reviewer's status; a new video created by an established reviewer with an elevated status (e.g., gold) and/or previous motivating videos may be placed earlier in a sequence, whereas a new video created by a novice reviewer may be placed further down in the sequence.

In accordance with one aspect of the present invention, the video testimonial is analogous to the “Uber” model, in that reviewers (like drivers) will self-populate the system if appropriately incented to do so. This allows product retailers to effectively crowd source a component of the advertising and marketing of their products, by incenting consumers to step up and endorse products, with very little overhead other than the incentives awarded to successful reviewers. At the same time, the incentive scheme is quintessentially Darwinian, in that only reviewers who create successful videos (defined in one embodiment as videos that motivate a product purchase) need to be incented or rewarded, whereas other reviewers whose videos do not motivate purchases need not be rewarded. This “natural selection” process allows the commercially important videos to be identified and strategically placed within the loop, and motivates their creators to produce additional videos through a program of incentives.

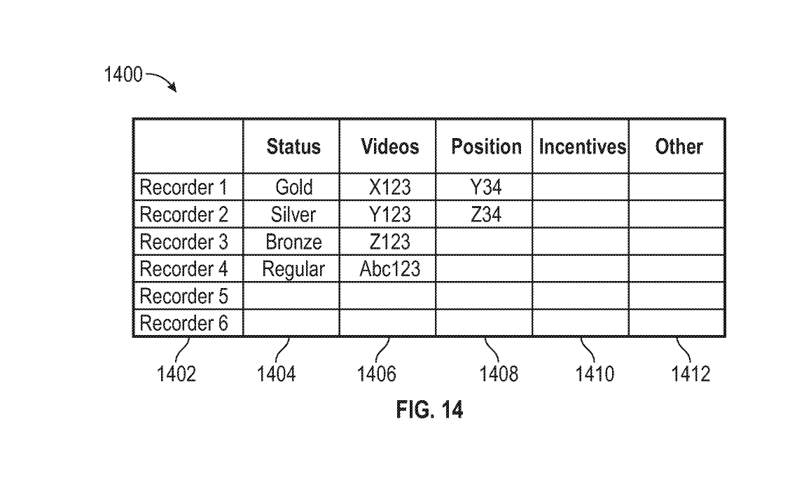

More particularly and referring now to FIG. 14, the system may utilize a database 1400 or similar scheme to track various metrics associated with videos, product sales, and video creators (referred to herein as reviewers). In an embodiment, a data structure 1400 may include, inter alia, a list 1402 of reviewer names or pseudo names and/or contact information (e.g., screen name, email address), the reviewers status 1404 (e.g., gold, silver, bronze, or any desired hierarchy), a list 1406 of each reviewer's videos for each of a plurality of products and web sites, each video's position 1408 within its loop, the incentives 1410 provided or available to the reviewer, and any other metric 1412 useful in implementing the features and functions described herein, including the number of products sold as a result of each video, the point in the video (time stamp) at which a customer clicked but now, total revenues attributable to a video, a reviewer, or per web site attributable to the techniques described herein, number of inquiries directed to a reviewer, number of “likes” or similar designations given to a video or to a reviewer, number of video views, temporal proximity between a viewed video and a product purchase, to and the like.

The foregoing database may be employed to automatically (e.g., algorithmically) adjust the position of one or more motivating videos within a sequence (loop), award points or other incentives to the creators of the motivating video(s), and/or adjust the status of respective reviewers based on product sales data, customer inquiries, and other parameters. By way of a non-limiting straightforward example, if a video is in the second position within a sequence, and a consumer views the first and second videos but only purchases the product after viewing the second video, the system may be configured to automatically designate the second video as a motivating video, and move the second video into the first position in the sequence. The system may then award the creator of the motivating video points or other incentives based on the video having been viewed, as well as the video being designated a motivating video.

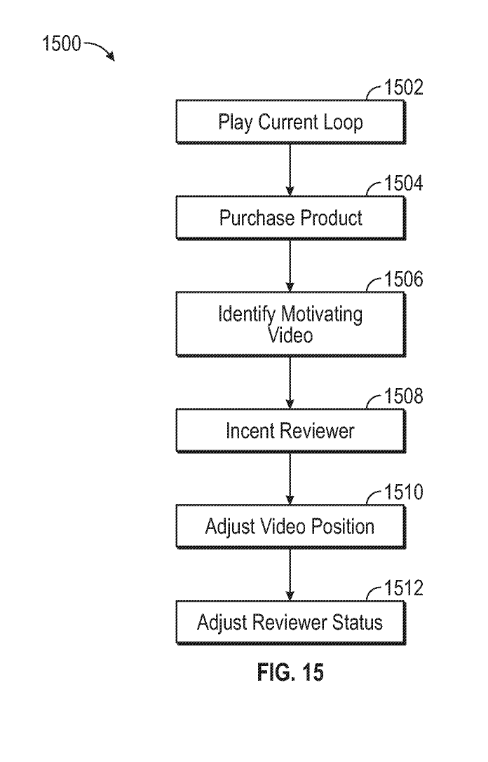

Referring now to FIG. 15, a flow diagram 1500 illustrates a method adjusting the status of a video and the status of the video's creator when a product is purchased based at least in part on a video. More particularly, a linked loop of videos is played (Task 1502), for example in response to a consumer clicking a product ad or clicking a VT or similar icon associated with a product ad. If the consumer purchases (Task 1504) the corresponding product while a video is being played, or shortly thereafter, the most recently viewed video may be deemed the motivating video (Task 1506); that is, although is difficult to conclusively establish that the consumer purchased the product as a direct result of watching a video, a temporal nexus between viewing an purchasing creates a strong inference that the video at least played a role in motivating the purchase.

With continued reference to FIG. 15, the system may be configured to incent or reward the reviewer of the motivating video (Task 1508), for example, by elevating the reviewer's status (which may involve additional privileges, discussed below), providing product discounts, or points which may be applied to product purchases or redeemed for other value including cash. The system may also be configured to adjust the motivating video's status (Task 1510), for example, by moving the video to an earlier position in the loop. In this regard, it may be desirable to place a video highest (e.g., first) in the loop if the video motivates purchases more so than any other video.

In an embodiment, if a purchaser elects to purchase a product (e.g., by clicking “buy now”) while a particular video is being viewed, the system may be configured to mark (e.g., time stamp) the specific point in the video at which the purchase decision was apparently made. In this way, the reviewer who created the video may infer that the point at which the video was time stamped constitutes a persuasive aspect of the video, informing the creator how to create more effective videos for the same or other products. That is, by knowing which portion of a video motivated a purchase decision, the creator may fine tune subsequent videos accordingly. Indeed, one benefit to achieving an elevated (e.g., gold) reviewer status may involve granting the reviewer access to time stamped videos created by other reviewers, to allow creators to leverage proven techniques employed by their contemporaries. This type of competitive yet cooperative ecosystem may motivate developers to create optimally effective videos, with very little overhead costs borne by the retailer.

In a further embodiment, achieving an elevated status (e.g., silver) may allow consumers to submit product questions directly to a reviewer, effectively promoting the reviewer as a de facto product spokesman (subject to administrative oversight by the product manufacturer or retailer). The reviewer may accumulate additional points for each query, and may also receive credit for sales to a customer after having communicated with a reviewer. By leveraging the reviewer community as product spokespersons, the retailer encourages relationships between consumers and reviewers to grow organically, while minimizing sales and marketing costs.

In a further embodiment, database 1400 may be used to support an interactive on-line user interface, whereby reviewers with an elevated status may review time stamped videos created by other reviewers, to allow the reviewer community to view successful motivation videos created by other reviewers, and thereby incorporate custom versions of proven sales techniques into their own videos.

While the present invention has been described in the context of the foregoing embodiments, it will be appreciated that the invention is not so limited. For example, various revenue models may be superimposed on the basic looping paradigms described above. In one embodiment, a basic membership may allow users to record and view looped videos; an upgraded membership may allow the testimonials to be downloaded. Moreover, a monthly fee may be charged for storing the videos in the cloud, with access fees also charged, as appropriate.

Computer code is also provided. The computer code is stored in a non-transient medium which, when executed by a computer processor, performs some or all of the steps described above.

A method of promoting on-line product sales is provided. The method includes: playing a sequence of video testimonials recorded by respective creators; identifying a motivating video in response to a product purchase; adjusting the position of the motivating video within the sequence; and providing a reward to the creator of the motivating video.

In an embodiment, the sequence comprises an endless loop.

In an embodiment, identifying the motivating video comprises determining a temporal nexus between a product purchase and the viewing of a video.

In an embodiment, the temporal nexus comprises a predetermined period of time.

In an embodiment, identifying the motivating video comprises time stamping the then-current video in response to a product purchase.

In an embodiment, providing the reward comprises providing indicia of the time stamp to the creator of the motivating video.

In another embodiment, providing the reward comprises elevating the status of the creator of the motivating video.

In an embodiment, an elevated status comprises permission to review time stamped motivating videos of other creators.

In an embodiment, the product purchase comprises detecting the selection of a buy now icon.

In an embodiment, adjusting the position of the motivating video comprises placing the video first in the sequence.

In an embodiment, the method further includes: identifying a second motivating video; and placing the first and second motivating videos within the sequence in accordance with predetermined priority metrics.

In an embodiment, the priority metrics include number of views and indicia of temporal proximity between the time at which a video was viewed and a product purchase.

A database structure is also provided for use in promoting on-line product sales. The database structure includes: a first list of reviewer identities; a second list of the respective status of each reviewer; a third list of videos produced by each reviewer; a fourth list of the then current position within a sequence for each video; and a fifth list of incentives provided to each reviewer.

Computer code embodied in a non-transient medium is also provided which, when executed by a computer processor, performs the steps of: presenting a viewer with a video testimonial (VT) icon proximate a product advertisement in an on-line retail web page; playing a sequence of video testimonials recorded by respective creators after detecting selection of the VT icon; identifying a motivating video in response to a product purchase; adjusting the position of the motivating video within the sequence; and providing a reward to the creator of the motivating video.

In an embodiment, the sequence comprises an endless loop; and identifying the motivating video comprises determining a temporal nexus between a product purchase and the viewing of a video.

In an embodiment, the temporal nexus comprises a predetermined period of time; and identifying the motivating video comprises time stamping the then-current video to indicate the location within the video at which a product purchase occurred.

In an embodiment, providing the reward comprises: elevating the status of the creator of the motivating video; and providing indicia of the time stamp to the creator of the motivating video and to other creators having at least a predetermined elevated status level.

In an embodiment, the product purchase is deemed to occur at the time at which a buy now icon is selected by a user.

In an embodiment the computer code is further configured to perform the steps of: identifying a second motivating video; and placing the first and second motivating videos within the sequence in accordance with predetermined priority metrics.

In an embodiment, the predetermined priority metrics include product sales revenue attributable to the respective motivating videos.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

We claim:

1. A method of promoting on-line product sales, comprising the steps of:
playing a sequence of video testimonials recorded by respective creators;
identifying a motivating video in response to a product purchase;
adjusting the position of the motivating video within the sequence; and
providing a reward to the creator of the motivating video.

2. The method of claim 1, wherein the sequence comprises an endless loop.

3. The method of claim 1, wherein identifying the motivating video comprises determining a temporal nexus between a product purchase and the viewing of a video.

4. The method of claim 3, wherein the temporal nexus comprises a predetermined period of time.

5. The method of claim 1, wherein identifying the motivating video comprises time stamping the then-current video in response to a product purchase.

6. The method of claim 5, wherein providing the reward comprises providing indicia of the time stamp to the creator of the motivating video.

7. The method of claim 1, wherein providing the reward comprises elevating the status of the creator of the motivating video.

8. The method of claim 7, wherein an elevated status comprises permission to review time stamped motivating videos of other creators.

9. The method of claim 1, wherein the product purchase comprises detecting the selection of a buy now icon.

10. The method of claim 1, wherein adjusting the position of the motivating video comprises placing the video first in the sequence.

11. The method of claim 1, further comprising the steps of:
identifying a second motivating video; and
placing the first and second motivating videos within the sequence in accordance with predetermined priority metrics.

12. The method of claim 11, wherein the priority metrics include number of views and indicia of temporal proximity between the time at which a video was viewed and a product purchase.

13. A database structure for use in promoting on-line product sales, the database structure comprising:
a first list of reviewer identities;
a second list of the respective status of each reviewer;
a third list of videos produced by each reviewer;
a fourth list of the then current position within a sequence for each video; and
a fifth list of incentives provided to each reviewer.

14. Computer code embodied in a non-transient medium which, when executed by a computer processor, performs the steps of:
presenting a viewer with a video testimonial (VT) icon proximate a product advertisement in an on-line retail web page;
playing a sequence of video testimonials recorded by respective creators after detecting selection of the VT icon;
identifying a motivating video in response to a product purchase;
adjusting the position of the motivating video within the sequence; and
providing a reward to the creator of the motivating video.

15. The computer code of claim 14, wherein:
the sequence comprises an endless loop; and
identifying the motivating video comprises determining a temporal nexus between a product purchase and the viewing of a video.

16. The computer code of claim 15, wherein:
the temporal nexus comprises a predetermined period of time; and
identifying the motivating video comprises time stamping the then-current video to indicate the location within the video at which a product purchase occurred.

17. The computer code of claim 16, wherein providing the reward comprises:
elevating the status of the creator of the motivating video; and
providing indicia of the time stamp to the creator of the motivating video and to other creators having at least a predetermined elevated status level.

18. The computer code of claim 16, wherein the product purchase is deemed to occur at the time at which a buy now icon is selected by a user.

19. The computer code of claim 18, further comprising:
identifying a second motivating video; and
placing the first and second motivating videos within the sequence in accordance with predetermined priority metrics.

20. The computer code of claim 19, wherein the predetermined priority metrics include product sales revenue attributable to the respective motivating videos.
